(19) United States
(12) Patent Application Publication
(10) Pub. No.: US 2013/0039309 A1
(43) Pub. Date: Feb. 14, 2013

(54) METHOD FOR RENEWING INDICATION OF SYSTEM INFORMATION AND BASE STATION AND USER EQUIPMENT USING THE SAME

(71) Applicant: Chun-Yuan Chiu, Pingtung County (TW)

(72) Inventor: Chun-Yuan Chiu, Pingtung County (TW)

(73) Assignee: INDUSTRIAL TECHNOLOGY RESEARCH INSTITUTE, Hsinchu (TW)

(21) Appl. No.: 13/584,825

(22) Filed: Aug. 14, 2012

Related U.S. Application Data
(60) Provisional application No. 61/523,393, filed on Aug. 14, 2011.

(30) Foreign Application Priority Data
Aug. 8, 2012 (TW) 101128624

(51) Int. Cl. H04W 74/08; H04W 72/04

(52) U.S. Cl. 370/329; 370/328

(57) ABSTRACT

A method for a method for renewing indication of system information, a base station using the same, a user equipment (UE) using the same, and a wireless communication system using the same is described. This disclosure proposes that renewing indication of system information and updating system information are not based on the traditional SIB (system information block) update and acquisition mechanisms. For the example of a random access (RA) procedure under extended access barring (EAB), an eNB could update EAB parameters at the time when the EAB SIB exists. Besides, a MTC (machine-type communication) device always assumes that the EAB is disabled & transmits preamble for RA directly. When the preamble is received by the eNB, the eNB notices the MTC device whether the EAB had been enabled or not. If EAB had been enabled, the MTC device interrupts current RA procedure, reads EAB SIB, and then performs EAB.

### CROSS-REFERENCE TO RELATED APPLICATION

This application claims the priority benefits of U.S. provisional application Ser. No. 61/523,393, filed on Aug. 14, 2011 and Taiwan application serial no. 101128624, filed on Aug. 8, 2012. The entirety of each of the above-mentioned patent applications is hereby incorporated by reference herein and made a part of this specification.

### TECHNICAL FIELD

The present disclosure generally relates to a method for renewing indication of system information, a base station using the same, a user equipment (UE) using the same, and a communication system using the same.

### BACKGROUND

Machine-Type Communication (MTC) is a very distinct capability that enables the implementation of the “Internet of things”. MTC is defined as information exchange between a subscriber station and a server through a base station or between subscriber stations in the core network of a wireless communication system. In contrast with human to human communications (H2H), MTC may be carried out without human interaction. As several industry reports have scoped out the huge potential for this market, some novel broadband wireless access systems, such as 3GPP Long Term Evolution (LTE) and IEEE 802.16m, are developing enhancements for these networks in order to accommodate for large volumes of M2M communications.

Although commissioning machine-type communications through a cellular network might enjoy the advantages of ubiquitous coverage, mobility support, communication in broadband, and low cost through using conventional wireless structures, the integration of devices using MTC is not without consequences as devices using MTC would need to share the already limited resources with normal user equipments (UE) for H2H communications. Since the potential quantities for MTC type of UEs could be enormous, a fast and efficient method of renewing indicators of system information without consuming extra network resources may be required to cope with the fluctuations of the large quantities of MTC UEs.

For instance, transpiration could be happened to the usage of the random access channel (RACH) used for performing uplink synchronization and bandwidth request before any data transmission begins. An evolved Node B (eNB) or a base station may configure a part of its resources to the RACH which is shared among all UEs. Since a large amount of MTCs could simultaneously request access, an RACH overload would inevitably occur. Therefore, communication networks must espouse a fast way to curtail high quantities of random accesses in order to prevent a network overload.

Consequently, a communication network such as the LTE has currently implemented a MTC specific access control mechanism, namely the Extended Access Barring (EAB) mechanism, in order to cope with the RACH overload. The EAB is summarized as follows. First, each of the UEs, including MTC devices, is assigned to an Access Class (AC) randomly numbered from 0 to 9 which is stored in the Universal Subscriber Identity Module (USIM). When EAB is activated by an eNB to prevent access overload, the eNB broadcasts the EAB information in a System Information Block (SIB) in which one bit is used to represent each of the AC numbers to indicate whether the AC number is permitted to access the Radio Access Network (RAN). If EAB is activated by the eNB, an UE configured for EAB will read the SIB containing the EAB information to check whether it is under the restriction of the EAB. If an UE happens to possess an AC number which indicates an access bar, then the UE will defer the access attempt. If the UE does not possess an AC number which indicates the access bar, then the UE passes the EAB and may access the RAN normally.

An eNB may enable the EAB, disable the EAB, or adjust EAB parameters. The eNB may make changes by modifying the system information of the eNB. The system information is written in System Information Blocks (SIB) which is broadcasted to UEs under the coverage of a cell in a periodic basis. Information related to EAB is located in SIBs. The system information in general may be changed by an eNB during the boundary of a modification period (MP). When an eNB decides to change the system information, the UEs under the coverage of the eNB may be notified by paging, which may be done throughout a modification period. In the following modification period, the eNB may transmit the SIBs with updated system information. An UE normally would not acquire SIBs unless a paging message containing an indicator to modify system information is received by the UE.

However, the traditional SIB update mechanism is not yet satisfactory for updating a system parameter such as the EAB at a real time basis. The system information may be broadcasted, for example, every 320 milliseconds. The broadcast periodicity is kept relatively short in order to accommodate UEs which may frequently move in and out of the broadcast range without having to wait for a long period to acquire system information. However, an eNB cannot make alterations to system information during every broadcast as it would mean that the UEs have to check whether the system information is altered more frequently than necessary. Instead, an eNB may only modify system information in boundaries of a modification period (MP), which may occur, for example, every 40 seconds. As the result of the long modification period, it is rather difficult for an eNB to instantaneously change the EAB parameters in case the random access (RA) load becomes heavy all in a sudden. An eNB may want to activate an EAB at the instant when RA load is heavy rather than waiting until the following MP boundary to change the system information. Also the long MP might cause difficulties for the UE to adapt new EAB parameters in order to perform random access, since an eNB may want to adjust the EAB parameters more frequently than the long MP allows. Therefore, a new method to perform EAB update without using the traditional SIB update mechanism is needed.

### SUMMARY

Accordingly, the present disclosure is directed to a method for renewing indication of system information, a base station using the same, a user equipment (UE) using the same, and a communication system using the same.

The present disclosure directs to a method of receiving updated system information, adapted for a base station, and an exemplary embodiment of the method including activating a first system event, broadcasting system information comprising parameters of the first system event periodically during the activation of the first system event, receiving a requesting access while the first system event is still activated, replying with a response corresponding to the received preamble, and notifying the activation of the first system event to in response to the requesting access by the response.

The present disclosure directs to a method of receiving updated system information, adapted for an user equipment, and an exemplary embodiment of the method including initiating a resource allocation request to perform a first communication procedure by transmitting a preamble, receiving a first response back in response to the transmission of the preamble, determining whether a first system event had been activated or not based on the received first response, transmitting or receiving according to the granted resource allocation request continuously while the first system event is disabled, and interrupting the first communication procedure while the first system event is activated.

An exemplary embodiment of the present disclosure directs to a base station which contains a transceiver and a processor. The transceiver is configured to transmit and receive wireless signals. The processor is coupled to the transceiver and is configured to determine whether an access barring mechanism is to be activated, wherein if the access barring mechanism is activated, the processor broadcasts through the transceiver system information comprising parameters of the access barring mechanism periodically during the activation of the access barring mechanism, receives through the transceiver at least a random access preamble during a request for a random access while the access barring mechanism is still activated, replies through the transceiver a random access response corresponding to the received random access preamble, and notifies the activation of the access barring mechanism in response to the request for the random access by the random access response.

An exemplary embodiment of the present disclosure directs to an user equipment which contains a transceiver and a processor. The transceiver is configured to transmit through the transceiver a random access preamble to initiate a random access procedure, receive through the transceiver a random access response, determine whether an access barring mechanism had been activated based on the received random access response, and interrupt the random access procedure after the access barring mechanism is determined to have activated.

An exemplary embodiment of the present disclose further includes a communication system which includes a base station and at least one user equipment. The base station is configured to determine whether an access barring mechanism is to be activated. If the access barring mechanism is activated, the base station broadcasts system information comprising parameters of the access barring mechanism periodically during the activation of the access barring mechanism, and the user equipment sends a requesting random access with a random access preamble to the base station. The base station replies a random access response corresponding to the receiving random access preamble to the user equipment to notify the activation of the access barring mechanism in response to the requesting random access by the random access response.

The accompanying drawings are included to provide a further understanding of the disclosure and are incorporated in and constitute a part of this specification. The drawings illustrate embodiments of the disclosure and, together with the description, serve to explain the principles of the disclosure.

### BRIEF DESCRIPTION OF THE DRAWINGS

FIG. 1 illustrates a wireless communication system including an eNB communicating with at least one UE in accordance with one of exemplary embodiments.

FIG. 2 illustrates a random access (RA) procedure according to one of exemplary embodiments.

FIG. 3 illustrates using the MAC header of a RAR message to indicate a system event according to one of exemplary embodiments.

FIG. 4 illustrates the RA procedure under a system event such as EAB according to one of exemplary embodiments.

FIG. 5 illustrates the RA procedure under EAB from the view point of an UE according to one of exemplary embodiments.

FIG. 6 illustrates the RA procedure under EAB from the view point of an eNB according to one of exemplary embodiments.

### DETAILED DESCRIPTION OF DISCLOSED EMBODIMENTS

In this disclosure, 3GPP-like keywords or phrases are used merely as examples to present inventive concepts in accordance with the present disclosure; however, the same concept presented in the disclosure can be applied to any other systems such as IEEE 802.11, IEEE 802.16, WiMAX, and so like by persons of ordinarily skilled in the art.

The term “eNodeB” or “eNB” in this disclosure may be, for example, a base station (BS), a Node-B, an advanced base station (ABS), a base transceiver system (BTS), an access point, a home base station, a relay station, a scatterer, a repeater, an intermediate node, an intermediary, and/or satellite-based communication base stations, and so like.

The term “user equipment” (UE) in this disclosure may be, for example, a mobile station, an advanced mobile station (AMS), a server, a client, a desktop computer, a laptop computer, a network computer, a workstation, a personal digital assistant (PDA), a tablet personal computer (PC), a scanner, a telephone device, a pager, a camera, a television, a hand-held video game device, a musical device, a wireless sensor, and so like. In some applications, a UE may be a fixed computer device operating in a mobile environment, such as a bus, train, an airplane, a boat, a car, and so like.

In this disclosure, a method to update system information indicator is proposed in the event of an extended access barring (EAB) for the Long Term Evolution (LTE) wireless communication network. However, the proposed method is not limited to EAB but may apply to other system events or in other wireless communication networks which is capable of adopting the method.

Presently, as Machine-Type Communication (MTC) becomes more prevalent, extended access barring (EAB) mechanism has been implemented in order to accommodate large volumes of M2M communications without RAN overload. For example, under LTE wireless communication network, an eNB informs UEs under its coverage that an EAB has been activated through paging, and EAB parameters may be accessed from SIBs located in the broadcasted system information. However, since the modification period of the system information is relatively long and might cope with a sudden surge of RA demands in real time, a method is proposed to perform EAB in order to prevent the RAN from overloading without being subject to the modification period.

The proposed method allows MTC type of UEs to disregard the modification period, and assumes that the EAB is disabled, and transmits a preamble for RA directly. The UEs would also initiate the RA by transmitting a preamble to the eNB regardless whether an EAB is activated or not. When the preamble is received by the eNB, the eNB follows up with a response message which may contain a notice for its UEs as to indicate whether the EAB had been activated or not.

If the EAB has been activated, the MTC device would then interrupt the first communication procedure (i.e., RA procedure). In addition, the MTC device under EAB would read the SIB containing the EAB parameters, and then apply the EAB. If the EAB bars the MTC device, the MTC device would then start a second communication procedure which may include a first sub-action and a second sub-action. If the EAB does not bar the MTC device, then MTC would re-initiate another RA procedure.

This noticing scheme is different from the conventional method, for which the eNB pages the UEs to inform the UEs that the system information which contains EAB parameters has been changed. If changes were made to EAB parameters under the conventional method, all UEs including normal H2H UEs would need to fetch the new system information of the eNB without delay as the new system information may be effective after the following MP boundary. For the method of the present disclosure however, the UEs are merely noticed without being required to update the system information of the eNB except for whom the EAB applies.

For a normal RA implementation without EAB between an eNB and an UE, a procedure could be as follows. An UE could initiate a RA by selecting a preamble code and transmit the preamble code to the eNB. When the preamble code is received by the eNB, the eNB will reply to the UE with a Random Access Response (RAR) message associated with the preamble code. The RAR message would include an uplink grant and other necessary information to the UE for accessing the wireless network. After the uplink (UL) grant is received by the UE, the UE would then use the resource allocation as indicated by the uplink grant to transmit a request message including an identity of the UE to the eNB in order to request RA from the eNB.

When the request message is received by the eNB, the eNB replies to the UE a second response message which includes an identity carried in the received request message. After the second response message is received by the UE, the UE would compare its own identity with the received identity. If the UE's identity matches the received identity, then UE would know that the data is intended for the UE, and the RA procedure would then be successfully completed. Otherwise, the UE would perform a back-off mechanism by waiting for a predetermined period before attempting another RA.

However, if the EAB is activated, an indicator specifically for indicating the activation of the EAB could be conveyed from an eNB to an UE in the RAR message. The message merely indicates that the EAB is in effect, and the eNB may update EAB parameters in system information without first paging the UEs. A RAR message would be encoded with packet data or Media Access Control Protocol Data Units (MAC PDU). The MAC PDU contains a MAC header followed by MAC payloads, and a MAC header further includes numerous sub-headers. In a MAC sub-header, there are two reserve bits would be used to indicate whether the EAB has been activated or not. Also since any UEs requesting for RA would need to read the MAC header regardless, using the reserve bits in the MAC sub-header would not result any extra overhead. When an UE receives the RAR message, it would decode the MAC PDUs from the RAR message and read two reserve bits in the MAC sub-header. If the EAB has been found to be active, the UE would read the SIB containing the EAB parameters and perform all the necessary subsequent operations under the EAB.

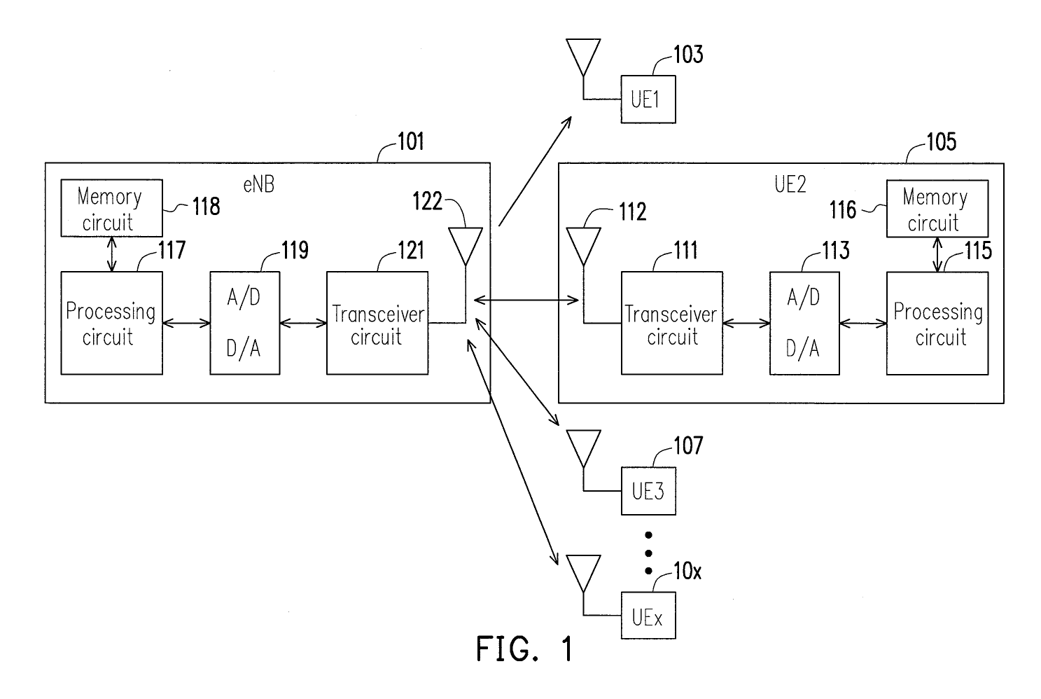

FIG. 1 illustrates a wireless communication system according to one of exemplary embodiments. The wireless communication system includes an eNodeB (101) in communication with at least one UEs (103, 105, . . . 10x) in accordance with a wireless communication standard. Each UE contains, for example, at least a transceiver circuit (111), an analog-to-digital (A/D)/digital-to-analog (D/C) converter (113), and a processing circuit (115). The transceiver circuitry (111) is capable of transmitting uplink signal and/or receives downlink signal wirelessly. The transceiver circuitry (111) may also perform operations such as low noise amplifying, impedance matching, frequency mixing, up or down frequency conversion, filtering, amplifying, and so like. The transceiver circuitry (111) also includes an antenna unit (117). The analog-to-digital (A/D)/digital-to-analog (D/C) converter (113) is configured to convert from an analog signal format to a digital signal format during downlink signal processing and digital signal format to analog signal format during uplink signal processing. The processing circuit (115) is configured to process digital signal and to perform procedures of the proposed method for data transmission in accordance with exemplary embodiments of the present disclosure. Also, the processing circuit (115) may include a memory circuit (116) to store data or record configurations assigned by the eNB (101). The eNB (101) contains similar elements including a transceiver unit (121) and a analog-to-digital (A/D)/digital-to-analog (D/C) converter (119) which lead to the converted digital signal to be processed by its processing circuitry (117) as well as using the memory circuit (118) so as to implement the method for data transmission in accordance with exemplary embodiments of the present disclosure.

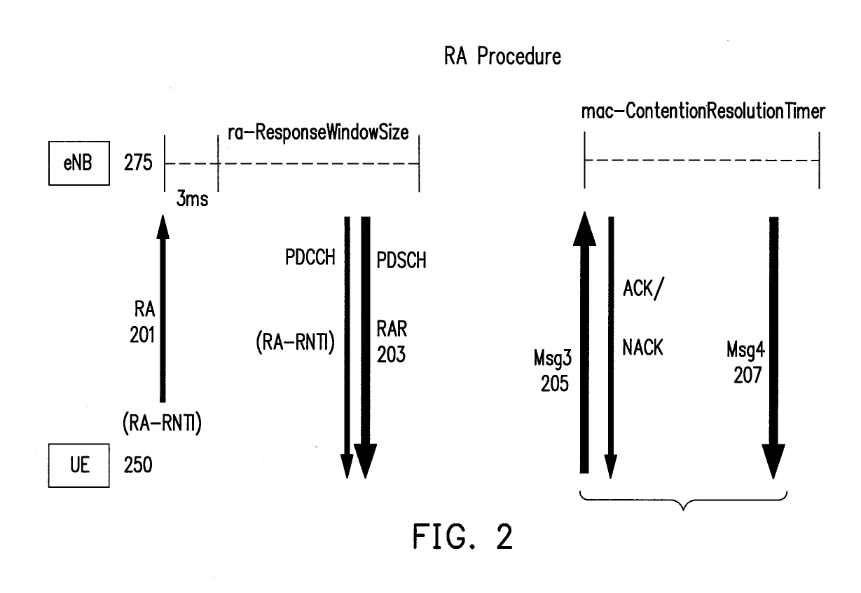

FIG. 2 illustrates a RA procedure performed between an eNB (275) and an UE (250) according to one of exemplary embodiments. In step 201, an UE (250) randomly selects a preamble code and transmits in a RA message (201) which contains the preamble code and a self identification number, RA-RNTI, to an eNB (275). When the eNB (275) receives the RA message (201), it may reply after 3 ms a RAR message (203) within a time window as indicated by the parameter ra-ResponseWindow Size, which could be 2, 3, 4, 5, 6, 7, 8, or 10 sub-frames. The RAR message (203) is encoded in sub-frames with each having a control region and a data region. The PDCCH in the control region carries control information with RA-RNTI identifier to identify the target of the RAR message (203), and the PDSCH in the data region contains MAC PDUs which carry payloads of data including an uplink grant.

After the UE (250) receives the RAR message (203), the UE (250) may read a reserve bit in MAC sub-headers of the MAC PDUs containing an indicator as to whether EAB has been activated or not. If the UE (250) learns that the EAB has been activated, the UE (250) interrupts the normal RA procedure and instead performs EAB procedures. If EAB had not been activated, the UE (250) may use the resource allocation information indicated by the uplink grant to transmit a message Msg3 (205) to the eNB (275) to request for RA. The Msg3 (205) transmitted by each UE may also include an unique self identity information such as the s-TMSI value. The eNB (275) may then transmit message Msg 4 (207) in a downlink assignment with payloads intended for the UE (250). The Msg4 (207) may also include identity information received from Msg3 (205). If the UE (250) finds an identity information in message Msg 4 (207) which matches its own identity information, then the UE (250) has found the payloads intended for the UE (250). At this point, the RA procedure is then complete. Otherwise, the UE would wait by performing a back-off mechanism before attempting a re-try for another RA.

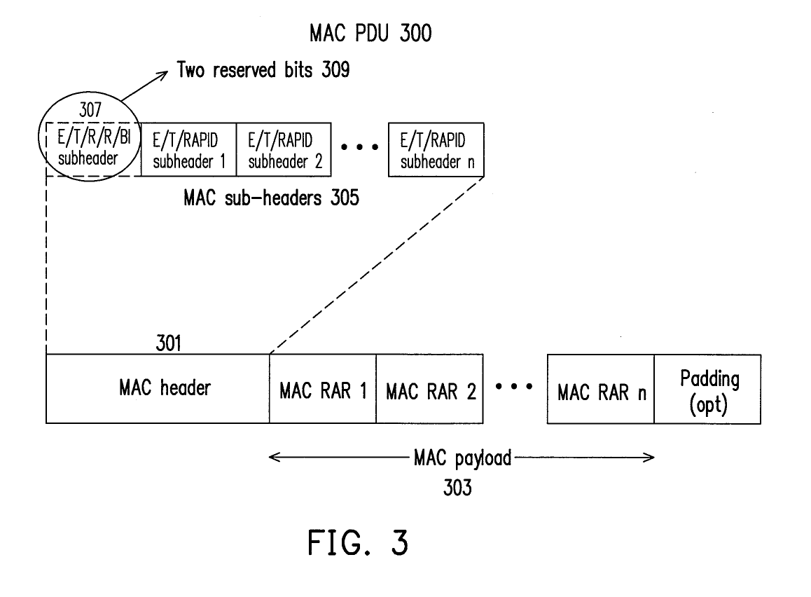

FIG. 3 illustrates the use of the RAR message to indicate whether EAB is enabled or not in one of exemplary embodiments. The RAR message could contain numerous packet data. A packet data unit or a MAC PDU (300) may contain a MAC header (301) followed by MAC payload (303). The MAC payload of an RAR message contains information of the RAR message and optional padding. Each sub-frame of the RAR message (MAC RAR1, MAC RAR2 . . . MAC RAR n) is read by an UE with a specific RA-RNTI information, and each sub-frame of the RAR message can be intended for a different UE.

A MAC header (301) contains numerous sub-headers (305). Each sub-header (307) contains at least 5 bits serving as indicators such as for indicating the sub-header type and whether there is anymore sub-headers. Within each sub-header (307), there could be two reserved bits (309). Any one of the two reserved bits (309) are used to indicate whether the EAB is activated or not. For example, a reserve bit with a binary value 1 could be that the EAB is active, and a 0 could mean that the EAB is not active. If the EAB are found to be active, the UEs would read the SIB and performs the EAB procedure. If the EAB is not active, then the UE would continue the normal RA procedure. In the case of LTE wireless network, since the use of reserved bits in the RAR message is in accordance with the current framework of the LTE, backward compatibility may be maintained.

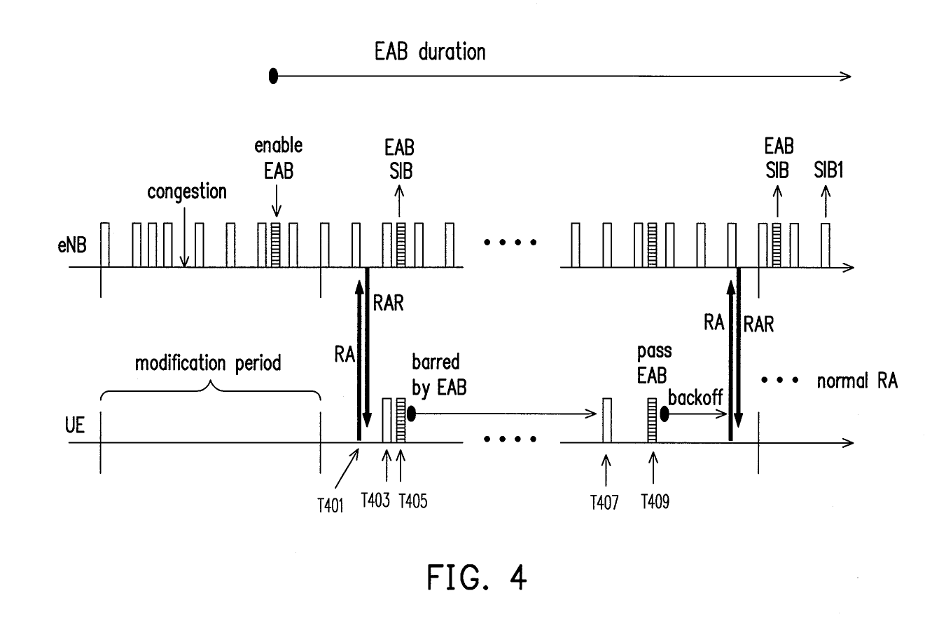

A more detailed RA procedure under EAB according to the exemplary embodiment is as follows. Referring to FIG. 4, first the eNB detects RACH congestion under heavy RA requests. Upon detecting the congestion, the eNB activates the EAB to bar from access certain UEs, such as MTC type of UEs. After the EAB has been activated, an UE of a MTC device requests a RA procedure at time point T401, but by doing so, the UE may first assume that the EAB is disabled by sending a preamble to an eNB directly. When the preamble is received by the eNB, a RAR message which contains an indicator represented by a reserved bit of the MAC header is sent back from the eNB to the UE. After the UE receives the RAR message, the UE may determine whether EAB is activated by reading the reserved bits in the RAR message.

If the EAB is disabled, the UE would perform the RA as it normally would. But since the EAB is already enabled under the scenario of FIG. 4 at time point T401, after receiving the RAR message, at time point T403 the UE would read the SIB1 to locate in the EAB SIB. In other words, the UE would read the first system information sub-block SIB1 which reveals the location of another SIB, a second system information sub-block containing the parameters of the EAB parameters or the EAB SIB. SIB1 is the first of the 13 system information blocks (SIB1-SIB 13). At time point T405, the UE reads the EAB SIB to fetch the EAB parameters, which may include the duration of the access bar. At time point T405, if the UE finds itself barred by the EAB, the UE would wait for the barring time (a first time period) to expire before reading the EAB parameters contained in the EAB SIB again. At time point T407, upon expiration of the barring time, the UE reads the SIB1 again to locate the EAB SIB and reads the EAB SIB. At the time point T409, the UE finds itself passing the EAB, even though the EAB may still be active. Upon learning that it is no longer barred by the EAB, the UE would perform a back-off for a random duration before attempting a normal RA.

The back-off period refers to a random period (a second time period) selected according to a statistical distribution in one embodiment. According to the statistical distribution, the waiting time of user equipments is uniformly distributed over time for user equipments which also pass the access barring mechanism. In other words, different user equipment which just comes off the EAB would wait for a different period randomly selected according to a statistical distribution. If there had not been a random back-off, all the multiple MTC UEs might attempt a RA at once and hence cause the RAN to overload. After the random back-off, the UE would have normal RA until it is barred again during the EAB duration.

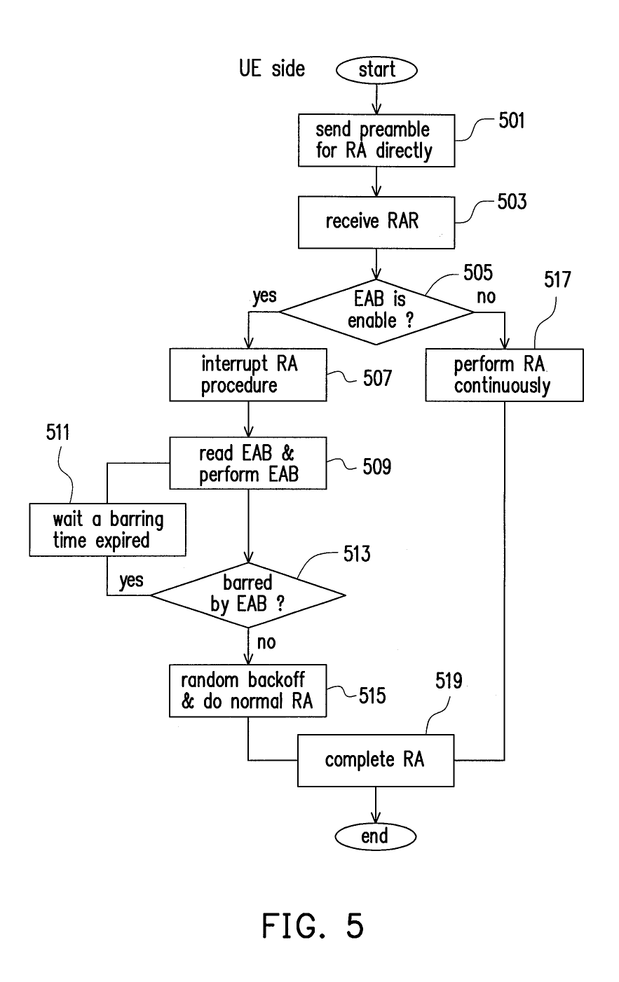

FIG. 5 illustrates renewing indication of system information during the RA procedure under EAB from the view point of an UE according to the exemplary embodiment. An UE by default contains cached parameters of system information which are broadcasted by the eNB periodically, and if needed, would have an opportunity to update system information parameters at every predefined period. But in the case when the normal system information mechanism is interrupted due to the activation of the EAB, an UE would regardless send a preamble to the eNB for the RA directly in step 501, which would also occur under normal circumstance.

In step 503, the UE receives back from the eNB a RAR message. The RAR message contains an indication as for whether the EAB has been activated or not. In step 505, the UE determines whether the EAB has been activated by the eNB. If the EAB is not enabled, the UE continues to perform the RA normally. If the EAB is activated, in step 507 the UE interrupts the RA procedure. Next in S509 the UE, reads the SIB1 and then find the EAB SIB which contains the EAB parameters. After reading EAB SIB, the UE then in S513 decides whether it has been barred by the EAB. If so, then in S511, the UE waits for the barring time to expire before looping back to step 509 to read the SIB1 again. If the UE has not been barred by the EAB, then the UE performs a back-off for a random duration in step 515 and then performs a normal RA. The back-off is useful for relieving the aggregation of RA attempts by a large number of UEs when the UEs pass the EAB.

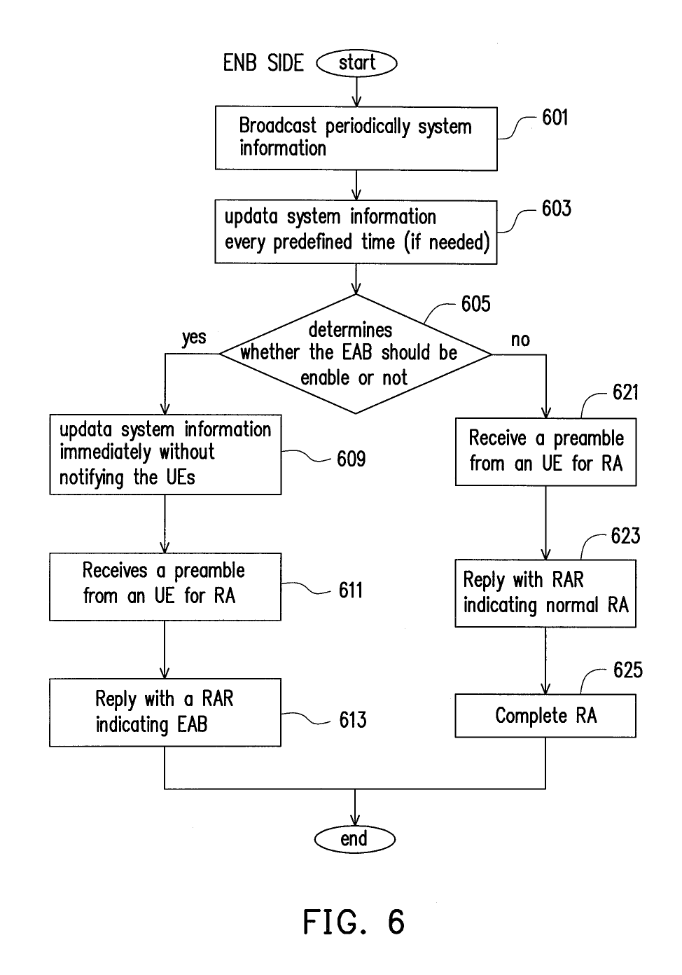

FIG. 6 illustrates renewing indication of system information during the RA procedure under EAB from the view point of an eNB according to one of exemplary embodiments. In step 601, the eNB broadcasts periodically parameters of system information, and in step 603 the eNB updates the system information at every predefined period in necessary. In step 605, the eNB determines whether the EAB should be activated or not based on whether a network overload might occur as the result of network congestion. If the EAB is not to be active, then in step 621, the eNB receives a preamble from an UE for a RA and in step 623 replies the UE with a RAR message indicating normal RA.

If in step 605 the eNB had determined that an EAB should be activated, then the eNB updates system information immediately without notifying the UEs. Next in step 611, the UE receives a preamble from an UE for a RA. In step 613, the eNB replies the UE with a RAR message which with an indicator which indicates EAB and does not continue with the normal RA.

The method of the disclosure possesses at least one or more of several advantages, but not limited thereto. At least one of the advantages is that the method has no impact on normal UEs or on MTC devices which do not request for a RA. Under the conventional method in which paging is involved, all UEs would need to decode from broadcasted system information EAB information, even though EAB has no pertinence for non-MTC UEs which do not request for a RA. By this proposed method, no extra overhead is necessary to update EAB notifications, since a reserved bit in a MAC header is used, and the reserve bit would have been read anyway by any UEs requesting for a RA. This proposed method, unlike the conventional method, does not have latency problem for adapting updated EAB information. This proposed method may not require UEs to acquire SIB needlessly except only when EAB has been enabled. Also as previously mentioned, the proposed method does not have the problem of aggregated RA attempts while the EAB no longer applies.

In short, the second communication procedure based on the parameters of the first system event commences when the user equipment finds itself affected by the first system event according to the parameters of the first system event. The first system event refers to as an extended access barring event. The second communication procedure contains a first sub-action and a second sub-action. If the user equipment is affected by the first system event, it would perform the first sub-action. Otherwise the first communication procedure is re-initiated. The first sub-action of the second communication procedure starting with the steps of at least but not only limited to waiting for a first period and updating the parameters of the first system event by reading a portion of the received system information after the first period expires. Reading a portion of the received system information refers to reading a portion of the received system information block. Then it determines whether the user equipment is affected by the first system event after the parameters of the first system event has been updated. If the user equipment is still affected by the first system event, re-performs the second communication procedure; otherwise at this point if the user equipment is no longer affected by the first system event, then it performs a second sub-action of the second communication procedure. The second sub-action contains at least the steps of waiting for a randomly selected second time period according to a statistical distribution which contains uniformly distributed waiting periods over time for multiple user equipments.

In view of the aforementioned descriptions, the present disclosure is suitable for being used in a wireless communication system and is able to renew indicators of system parameters instantaneously when necessary without requiring extra overhead or needless system information acquisition while maintaining backward compatibility. Accordingly, by having a well-designed EAB algorithm, the EAB could be optimally performed and potential network overlords can be averted.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A base station, comprising:
a transceiver configured to transmit and receive wireless signals; and
a processor coupled to the transceiver and configured to determine whether an access barring mechanism is to be activated, wherein if the access barring mechanism is activated, the processor
broadcasts through the transceiver a system information comprising parameters of the access barring mechanism periodically during the activation of the access barring mechanism,
receives through the transceiver at least a random access preamble during a request for a random access while the access barring mechanism is still activated,
replies through the transceiver a random access response corresponding to the random access preamble, and
notifies the activation of the access barring mechanism in response to the request for the random access by the random access response.

2. The base station of claim 1 wherein after activating the access barring mechanism, the processor further comprises:
writing the parameters of the access barring mechanism in the system information; and
updating the parameters of the access barring mechanism in the system information without paging.

3. The base station of claim 1 wherein the random access response comprises an indicator to indicate whether the access barring mechanism is activated in a header of a packet data unit.

4. The base station of claim 3 wherein the indicator is a reserved bit located in each sub-header of the header of the packet data unit according to a format of a Long Term Evolution (LTE) wireless communication system.

5. The base station of claim 1 wherein the access barring mechanism is extended access barring (EAB) for a Long Term Evolution (LTE) wireless communication system.

6. A method for receiving updated system information, adapted for a base station, the method comprising:
activating a first system event;
broadcasting a system information comprising parameters of the first system event periodically during the activation of the first system event;
receiving a requesting access while the first system event is still activated;
replying with a response corresponding to a received preamble; and
notifying the activation of the first system event to in response to the requesting access by the response.

7. The method of claim 6, wherein after activating the first system event, the method further comprises:
writing the parameters of the first system event in the system information; and
updating the parameters of the first system event in the system information without paging.

8. The method of claim 6 wherein the response comprises an indicator to indicate whether the first system event is activated in a header of a packet data unit by using a reserved bit located in each sub-header of the header of the packet data unit according to a format of a Long Term Evolution (LTE) wireless communication system.

9. The method of claim 6, wherein the first system event is an extended access barring event in accordance with a Long Term Evolution (LTE) wireless communication system.

10. A communication system, comprising:
A base station, configured to determine whether an access barring mechanism is to be activated; and a user equipment, wherein
If the access barring mechanism is activated, the base station broadcasting a system information comprising parameters of the access barring mechanism periodically during the activation of the access barring mechanism,
the user equipment sending a requesting random access with a random access preamble to the base station, the base station replying a random access response corresponding to receiving the random access preamble to notify the activation of the access barring mechanism in response to the requesting random access by the random access response.

11. An user equipment comprising:
a transceiver configured to transmit and receive wireless signals; and
a processor coupled to the transceiver and configured to:
transmit through the transceiver a random access preamble to initiate a random access procedure,
receive through the transceiver a random access response,
determine whether an access barring mechanism had been activated based on the random access response, and
interrupt the random access procedure after the access barring mechanism is determined to have activated.

12. The user equipment of claim 11 wherein the processor is further configured for:
reading parameters of the access barring mechanism from a received system information when the access barring mechanism is determined to have activated; and
performing the access barring mechanism.

13. The user equipment of claim 12 wherein performing access barring mechanism comprises:
determining whether the user equipment is barred by the access barring mechanism based on the received system information; and
if the user equipment is barred by the access barring mechanism, waiting for a first time period to expire.

14. The user equipment of claim 13 wherein the configuration of the processor further comprises:
If the user equipment is not barred by the access barring mechanism, continuing the random access procedure by initiating another random access procedure.

15. The user equipment of claim 13 wherein after waiting for the first time period to expire, the configuration of the processor further comprises:
updating parameters of the access barring mechanism based on the received system information;
determining whether the user equipment passes the access barring mechanism while the access barring mechanism is still activated; and
performing the access barring mechanism again if the user equipment is still barred by the access barring mechanism.

16. The user equipment of claim 15 wherein the configuration of the processor further comprises:
if the user equipment passes the access barring mechanism, waiting for a second time period wherein the second time period is a randomly selected time period according to a statistical distribution which contains uniformly distributed waiting periods over time for multiple user equipments
continuing the random access procedure while the user equipment is not barred by the access barring mechanism.

17. The user equipment of claim 11 wherein the random access response comprises an indicator indicating whether the access barring mechanism is activated in a header of a packet data unit.

18. The user equipment of claim 17 wherein the indicator is a reserved bit located in each sub-header of the header of the packet data unit wherein the packet data unit is accordance with a format of a Long Term Evolution (LTE) wireless communication system.

19. A method for receiving updated system information, adapted for an user equipment, the method comprising:
initiating a resource allocation request to perform a first communication procedure by transmitting a preamble;
receiving a received first response in response to the preamble;
determining whether a first system event had been activated or not based on the received first response;
transmitting or receiving according to a granted resource allocation request continuously while the first system event is disabled; and
interrupting the first communication procedure while the first system event is activated.

20. The method of claim 19, wherein the step of determining whether the first system event had been activated or not based on the received first response comprises:
determining whether the first system event had been activated or not based on the received first response by reading a header of packet data decoded from the received first response.

21. The method of claim 20, wherein reading the header of packet data decoded from the received first response comprises:
reading a reserve bit within each sub-header of a header of a packet data decoded from the received first response, wherein a format of the packet data is in accordance with a Long Term Evolution (LTE) wireless communication system and the reserve bit indicates whether the first system event has been activated or not.

22. The method of claim 19 wherein the method further comprises:
reading parameters of the first system event by accessing a received system information after interrupting the first communication procedure; and
performing a second communication procedure according to the parameters of the first system event.

23. The method of claim 22 wherein the step of performing the second communication procedure according to the parameters of the first system event comprises:
determining whether the user equipment is affected by the first system event according to the parameters of the first system event;
if the user equipment is affected by the first system event, performing a first sub-action of the second communication procedure; otherwise
re-initiating the first communication procedure.

24. The method of claim 23 wherein the first sub-action of the second communication procedure comprises:
waiting for a first period; and
updating the parameters of the first system event by reading a portion of the received system information after the first period expires.

25. The method of claim 24 further comprises:
determining whether the user equipment is affected by the first system event after the parameters of the first system event has been updated;
if the user equipment is still affected by the first system event, performing the second communication procedure; otherwise
if the user equipment is no longer affected by the first system event, performing a second sub-action of the second communication procedure.

26. The method of claim 25 wherein the second sub-action comprises:
waiting for a randomly selected second time period according to a statistical distribution which contains uniformly distributed waiting periods over time for multiple user equipments.

27. The method of claim 19 wherein the first communication procedure is a random access procedure in accordance with a Long Term Evolution (LTE) wireless communication system.

28. The method of claim 19 wherein the first system event is an extended access barring (EAB) event in accordance with a Long Term Evolution (LTE) wireless communication system.

29. The method of claim 19 where a first response is a random access response in accordance with a Long Term Evolution (LTE) wireless communication system.

30. The method of claim 22 wherein the step of reading the parameters of the first system event comprises:
reading a first system information sub-block from a broadcasted system information;
obtaining a location of a second system information sub-block from reading the first system information sub-block; and
obtaining the parameters of the first system event from the second system information sub-block.
